(19) United States
(12) Patent Application Publication
(10) Pub. No.: US 2019/0375293 A1
(43) Pub. Date: Dec. 12, 2019

(54) STEPPED LIGHT GUIDE FOR SIMULTANEOUS ILLUMINATION OF GRAPHICS AND CHAPLET TICKMARKS ON A VEHICLE INSTRUMENT PANEL DIAL

(71) Applicant: Continental Automotive Systems, Inc., Auburn Hills, MI (US)

(72) Inventors: Vyacheslav Birman, Auburn Hills, MI (US); Curt Ollila, Fenton, MI (US); Ulises Mendoza de la Torre, Tlaquepaque (MX)

(21) Appl. No.: 16/431,231

(22) Filed: Jun. 4, 2019

Related U.S. Application Data
(60) Provisional application No. 62/683,150, filed on Jun. 11, 2018.

(51) Int. Cl. B60K 35/00

(52) U.S. Cl. CPC B60K 35/00; B60K 2370/336; B60K 2370/695

(57) ABSTRACT

A block of light-transmissive material having a substantially planar top surface and a stepped bottom surface provides uniform or at least substantially uniform luminance to both graphics and tickmarks on a dial face for a motor vehicle instrument panel dial. The tickmarks are embodied as light-transmissive protuberances from the top surface.

### BACKGROUND

Motor vehicle instrument panels are provided with dials that have both “chaplet tickmarks” or simply “tickmarks” and graphics, symbols, icons or lettering. The amount of light emitted from the tickmarks and graphics symbols, icons or lettering is usually different, which reduces their visibility. A dial for an instrument panel that provided even or at least better illumination from both tickmarks and graphics would be an improvement over the prior art.

### BRIEF DESCRIPTION OF THE FIGURES

FIG. 1 is a cross section of stepped light guide for simultaneous illumination of both graphics and chaplet tick marks (or tickmarks) on a vehicle instrument panel dial;

FIG. 2 is a cross section of an assembly of the lightguide shown in FIG. 1, a light housing and a dial for a motor vehicle, i.e., a vehicle instrument panel dial;

FIG. 3 is a front view of the light guide with air gaps to decrease the light flux from the thicker zone shown in FIG. 1 to the thinner zone; and

FIG. 4 is a schematic depiction of an alternate embodiment of a stepped light guide for simultaneous illumination of both graphics and chaplet tick marks (or tickmarks) on a vehicle instrument panel dial.

### DETAILED DESCRIPTION

As used herein “luminance” refers to a photometric measure of the luminous intensity per unit area of light travelling in a given direction. Stated another way, “luminance” describes the amount of light that passes through, or which is emitted from or reflected from a particular area of a surface, regardless of whether the surface is flat or curved.

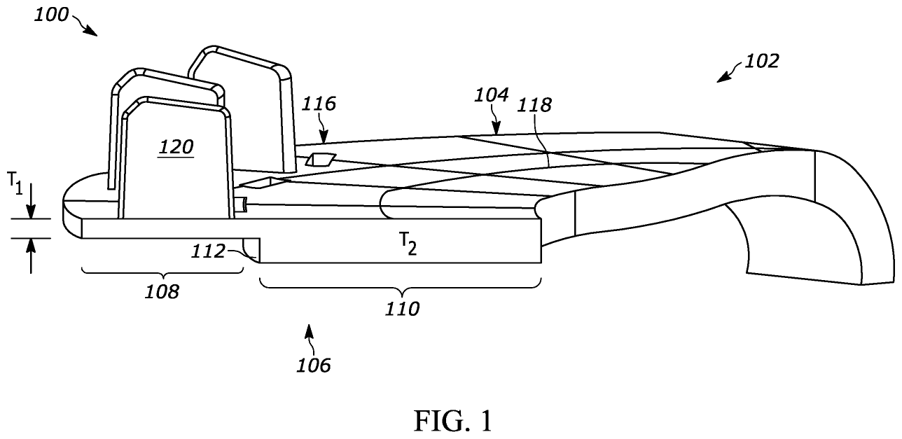

FIG. 1 is a cross section of stepped light guide 100 for simultaneous illumination of both graphics and chaplet tickmarks on a vehicle instrument panel dial. The light guide 100 is made up of a block of light-transmissive material 102 having a substantially planar top surface 104 and a stepped bottom surface 106.

The block 102 is monolithic; it does not have joints or seams. It is nevertheless considered herein as having two ostensibly separate portions 108, 110, which are contiguous but have different thicknesses. Their thicknesses are determined by reference to the substantially planar top surface 104. The different thicknesses make the bottom surface 106 have a step between the two portions 108, 110.

The two portions 108, 110 of the block 102 are contiguous but for purposes of description and claiming, they are also considered as being defined or separated from each other by another surface identified by reference numeral 112, and which is reminiscent of a vertical riser between two stair treads. The vertical (as shown) surface 112 “separating” the two different-thickness portions 108, 110 is actually part of the thicker portion 110 but is nevertheless referred to herein as a riser and considered to be a structure.

As can be seen in FIG. 1, the first portion 108 has a first thickness, t1, relative to the top surface 104. The second portion 110 has a second and greater thickness, t2, relative to the top surface 104.

The planar top surface 104 is considered as having a first substantially planar region 116 that is located over the first, thinner portion 108 of the block 102. The top surface 104 also has a physically contiguous but for claiming purposes, a separate and second substantially planar region 118 that is located over the thicker, second portion 110 of the block 102.

The first substantially planar region has a substantially parallelepiped-shaped protuberance 120 extending upwardly from the first substantially planar region 116 of the substantially planar top surface 104. The substantially parallelepiped-shaped protuberance 120 is a “chaplet tickmark” or simply “tickmark,” for a motor vehicle instrument panel dial not shown in FIG. 1. The thicknesses t1 and t2 determine the brightness or luminance of light transmitted into and thus emitted from the protuberance 120.

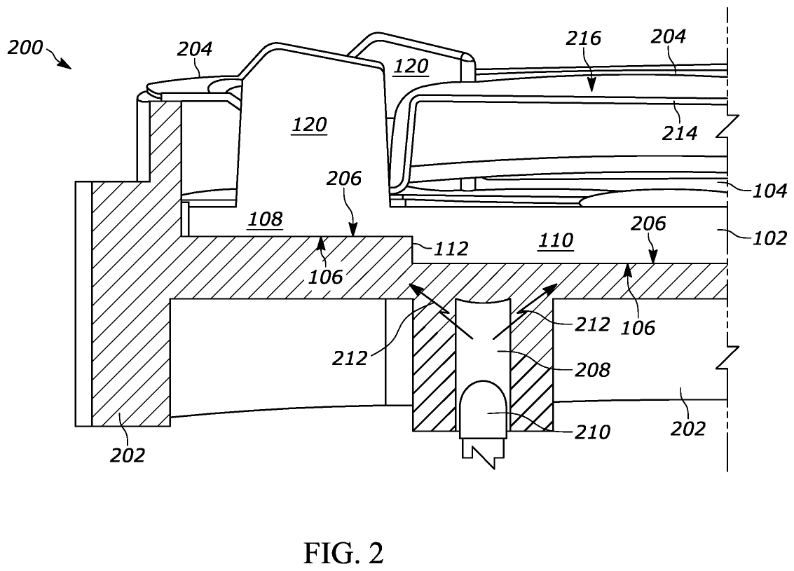

FIG. 2 is a cross section of an assembly of the lightguide shown in FIG. 1 and which comprise a motor vehicle instrument panel dial 200 or simply instrument panel dial 200. The cross section shows the block of light-transmissive material 102, a light housing 202 underneath the block 102 and thus below its bottom 106, and, a dial face 204 above the block 102 and thus above its top surface 104. Together, the structures shown in FIG. 2 comprise a motor vehicle instrument panel dial 200.

The light housing 202 has its own top surface 206, the shape of which is complementary to the shape of the bottom surface 106 of the block of light-transmissive material 102. A substantially cylindrical receptacle 208 is sized and shaped or “configured” to receive a light source such as a bulb or light emitting diode (LED) 210. Light from the light source is transmitted into the bottom 106 of the block of light-transmissive material 102 and propagated by the block 102 to the protuberance 120 and the planar section 118 in substantially equal “amount” such that the luminance of light emitted from the protuberance or tickmark 120 is substantially the same as the luminance of the light emitted from the planar section 118.

Still referring to FIG. 2, an instrument panel dial face 204 located above the substantially planar top surface 104 of the block 102 is light transmissive. It has its own bottom surface 214 and top surface 216. The bottom surface 214 faces the substantially planar top surface 104 of the block of light-transmissive material 102. The top surface 216 has information-bearing markings, well-known to those or ordinary skill in the motor vehicle instrumentation art but not visible in FIG. 2 because FIG. 2 is a cross section.

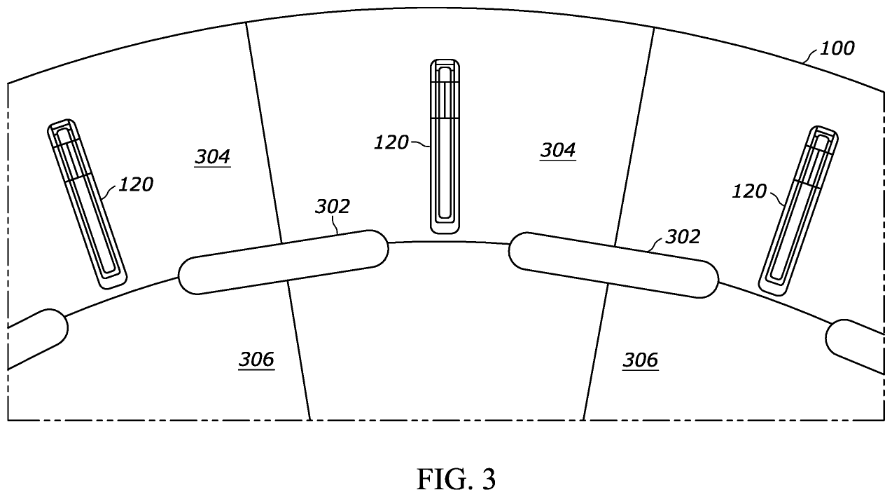

FIG. 3 is a front view of the light guide 100 showing multiple tickmarks 120 but also with air gaps 302 that separate or define two illumination areas or zones 304, 306. The size or height of the step or riser 112 between the second portion 110 or “graphics area” and the first portion 108 or “tickmarks area” controls the amount of light transmitted into each portion 108, 110 from the light source 210. The holes 302 are sized, shaped and located between tickmarks 120 to control the amount of light in the smaller area 304.

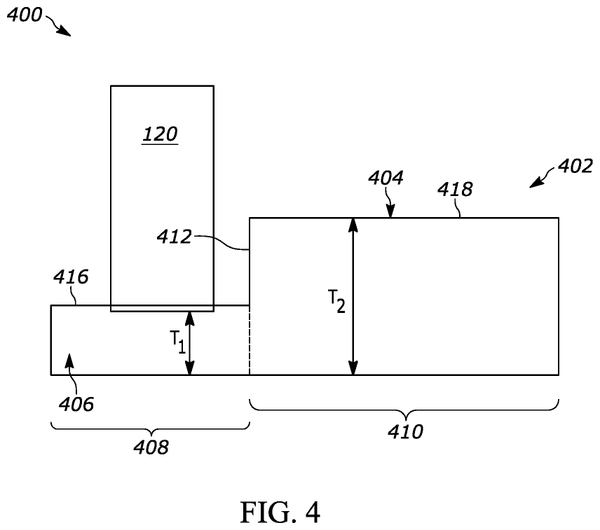

FIG. 4 is a schematic depiction of an alternate embodiment of a stepped light guide 400 for simultaneous illumination of both graphics and chaplet tick marks (or tickmarks) on a vehicle instrument panel dial. The light guide 400 is made up of a block of light-transmissive material 402 having a stepped top surface 404 and a substantially planar bottom surface 406.

The block of light transmissive material 402 is monolithic; it does not have joints or seams. As with the block 102 shown in FIG. 2, the block 402 in FIG. 4 is nevertheless considered herein as having two ostensibly separate portions 408, 410, which are contiguous but have different thicknesses. Their thicknesses are determined by reference to the substantially planar bottom surface 406. The different thicknesses of the two portions 408, 410 make the top surface 404 form or have a “step” between the two portions 408, 410.

The two portions 408, 410 of the block 402 are contiguous but for purposes of description and claiming, they are also considered as being defined or separated from each other by another surface identified by reference numeral 412, and which is also reminiscent of a vertical riser between two stair treads. The vertical (as shown) surface 412 “separating” the two different-thickness portions 408, 410 is actually “part of” the thicker portion 410 but is nevertheless referred to herein as a riser and considered to be a structure.

The first portion 408 of the block 402 has a first thickness, t1, relative to the bottom surface 406. The second portion 410 has a second and greater thickness, t2, relative to the bottom surface 404. The thickness difference between the two portions is changed to change the brightness or luminance of light emitted from a substantially parallelepiped-shaped protuberance 120 extending upwardly from the first substantially planar region 416 of the stepped top surface 404.

As shown in the figure, the stepped top surface 404 is considered as having a first substantially planar region 416 located at the top of the first, thinner portion 408 of the block 402. The top surface 404 also has a physically contiguous but for claiming purposes, separate and second substantially planar region 418 that is located over the thicker, second portion 410 of the block 402.

The first substantially planar region 416 has the aforementioned substantially parallelepiped-shaped protuberance 120 extending upwardly from the first substantially planar region 416 of the stepped top surface 404. The substantially parallelepiped-shaped protuberance 120 is a “chaplet tickmark” or simply “tickmark,” for an motor vehicle instrument panel dial. The thicknesses of 408 and 410 determine the luminance of the light emitted from the protuberance 120.

Those of ordinary skill in the art should recognize that by providing a light housing as shown in FIG. 2, underneath the block 402 and thus below its bottom 406 and a dial face as shown in FIG. 2 and above the block 402 and thus above its top surface 404 comprise another embodiment of motor vehicle instrument panel dial 200.

Those of ordinary skill in the art should also recognize that the luminance of the blocks 102 and 402 can be increased and decreased by the roughness of the surfaces of the light block. Various alternate embodiments thus have light blocks 102 and 402, the exterior surfaces of which are polished, abraided or grooved.

The foregoing description is for purposes of illustration and explanation. The true scope of the invention is set forth in the following claims.

What is claimed is:

1. A light guide that provides substantially uniform illumination of both graphics and chaplet tickmarks of a vehicle instrument panel dial, the graphics and chaplet tickmarks of the dial being spatially separated from each other on the dial, such that they are located in spatially separate regions of the dial, the light guide comprising:
a block of light-transmissive material having a top surface and a stepped bottom surface, the stepped bottom surface being defined by a first portion of the block that has a first thickness and a second portion of the block, contiguous with the first portion of the block but which has a second thickness, the first and second portions of the block being adjacent to and contiguous with each other and separated by a riser, the top surface having a first substantially planar region located over the first portion of the block and a second substantially planar region located over the second portion of the block, the first substantially planar region having a substantially parallelepiped-shaped protuberance extending upwardly from the first substantially planar region of the substantially planar top surface, the substantially parallelepiped-shaped protuberance being a chaplet tickmark for the instrument panel dial.

2. The light guide of claim 1, wherein the first thickness is less than the second thickness.

3. The light guide of claim 1, wherein the top surface is substantially planar.

4. The light guide of claim 1, further comprising a light source, the light source being optically coupled to the block such that it is provides visible light into the block of light transmissive material, wherein visible light from the light source is emitted from the chaplet tickmark and from the second, substantially planar region of the top surface, the light emitted from the chaplet tickmark and the light emitted from the top surface having substantially the same luminance.

5. The light guide of claim 2, further comprising an instrument panel dial face located above the substantially planar top surface, the instrument panel dial being light transmissive and having a bottom surface and a top surface, the bottom surface of the dial face facing the substantially planar top surface of the block of light-transmissive material, the top surface of the dial face having information-bearing markings.

6. The light guide of claim 3, further comprising a light housing located below and physically contacting the stepped bottom surface of the block of light transmissive material.

7. The light guide of claim 4, wherein the light housing has a top surface that is complementary to the stepped bottom surface of the block of light-transmissive material and wherein the light housing has a receptacle in its bottom surface, which is configured to receive the light source and transmit light from the light source into the stepped bottom surface of the block of light-transmissive material.

8. The light guide of claim 1, further comprising an air gap between the first and second portions of the block of light transmissive material.

9. A light guide that provides substantially uniform illumination of both graphics and chaplet tickmarks of a vehicle instrument panel dial, the graphics and chaplet tickmarks of the dial being spatially separated from each other on the dial, such that they are located in spatially separate regions of the dial, the light guide comprising:
a block of light-transmissive material having a substantially planar bottom surface and a stepped top surface, the stepped top surface being defined by a first portion of the block that has a first thickness and a second portion of the block, contiguous with the first portion of the block but which has a second thickness, the first and second portions of the block being adjacent to and contiguous with each other and separated by a riser, the top surface having a first substantially planar region located over the first portion of the substantially planar bottom surface of the block and a second substantially planar region located over the second portion of the block, the first substantially planar region having a substantially parallelepiped-shaped protuberance extending upwardly from the first substantially planar region of the stepped top surface, the substantially parallelepiped-shaped protuberance being a chaplet tickmark for the instrument panel dial.

10. The light guide of claim 9, wherein the first thickness is less than the second thickness.

11. The light guide of claim 9, further comprising a light source, the light source being optically coupled to the block of light transmissive material such that it provides visible light into the block of light transmissive material, wherein visible light from the light source is emitted from the chaplet tickmark and from the second region of the top surface, the light emitted from the chaplet tickmark and the light emitted from the top surface having substantially the same luminance.

12. The light guide of claim 11, further comprising an instrument panel dial face located above the stepped top surface, the instrument panel dial being light transmissive and having a bottom surface and a top surface, the bottom surface of the dial face facing the stepped top surface of the block of light-transmissive material, the top surface of the dial face having information-bearing markings.

13. The light guide of claim 12, further comprising a light housing located below and physically contacting the substantially planar bottom surface of the block of light transmissive material.

14. The light guide of claim 13, wherein the light housing has a top surface that is complementary to the bottom surface of the block of light-transmissive material and wherein the light housing has a receptacle configured to receive the light source and transmit light from the light source into the bottom surface of the block of light-transmissive material.
